(19) United States
(12) Patent Application Publication
(10) Pub. No.: US 2011/0232478 A1
(43) Pub. Date: Sep. 29, 2011

(54) CYLINDER LINER

(75) Inventors: Masami Horigome, Sagae-shi (JP); Giichiro Saito, Sagae-shi (JP)

(73) Assignees: TEIKOKU PISTON RING CO., LTD., Chiyoda-ku (JP); TEIPI INDUSTRY CO., LTD., Sagae-shi (JP)

(21) Appl. No.: 13/042,963

(22) Filed: Mar. 8, 2011

(30) Foreign Application Priority Data
Mar. 25, 2010 (JP) 2010-070245

(51) Int. Cl. F16J 10/04

(52) U.S. Cl. 92/169.1

(57) ABSTRACT

The present invention provides a cylinder liner excellent in adhesion and heat conductivity with a cylinder block. The cylinder liner 1 of the present invention is formed from cast iron or steel. The cylinder liner 1 is formed with a thermal sprayed coated film 6 at its outer circumferential surface 3 and top surface 4. As the thermal sprayed material, Al, an Al alloy, Fe, an Fe alloy, Zn, a Zn alloy, Cu, a Cu alloy, etc. is used. The cylinder liner 1 is cast around a cylinder block formed from an aluminum alloy or other light alloy, by insert casting, at its outer circumferential surface 3, top surface 4, and bottom surface 5. The cylinder liner 1 is chamfered at the connecting edges of its top surface 4 and inner circumferential surface 7. The thermal sprayed coated film 6 is preferably formed at the top surface 4 part to extend over the chamfering part.

This application claims benefit of Serial No. 2010-070245, filed 25 Mar. 2010 in Japan and which application is incorporated herein by reference. To the extent appropriate, a claim of priority is made to the above disclosed application.

### TECHNICAL FIELD

The present invention relates to a cylinder liner cast around a cylinder block by insert casting.

### BACKGROUND ART

In automobile engines, sometimes a cylinder block made of an aluminum alloy etc. has a cylinder liner made of cast iron etc. cast around it by insert casting. In this case, since the cylinder liner and the cylinder block are different in physical properties, sometimes a clearance etc. forms between the cylinder liner and the cylinder block. To solve this problem, in Japanese Patent Publication (A) No. 2008-8209, the cylinder liner has a thermal sprayed coated film of aluminum or aluminum alloy formed on its outer circumferential surface.

### SUMMARY OF THE INVENTION

In Japanese Patent Publication (A) No. 2008-8209, by thermal spraying the cylinder liner at the outer circumferential surface, the adhesion between the cylinder liner and the cylinder block is improved and an improvement in the bond strength and heat conductivity is obtained. However, thermal spraying the cylinder liner at the top surface is not described.

An object of the present invention is to provide a cylinder liner excellent in adhesion and heat conductivity with a cylinder block.

To solve this problem, the present invention adopts the following solution to the problem. That is, the present invention provides a cylinder liner cast around a cylinder block by insert casting characterized in that a thermal sprayed coated film is formed at the top surface and outer circumferential surface.

In the above, the connecting edges of the top surface and the inner circumferential surface are preferably chamfered and the thermal sprayed coated film of the top surface part is formed so as to extend over the chamfering part. The chamfered surface is preferably a slanted surface or curved surface.

According to claim 1, when the cylinder liner is cast over not only the outer circumferential surface, but also the top surface, by insert casting, the bond strength and heat conductivity of the cylinder liner and cylinder block are excellent. According to claim 2, the adhesion of the thermal sprayed coated film at the cylinder liner top surface is improved. According to claim 3, the adhesion of the thermal sprayed coated film is further improved.

### BRIEF DESCRIPTION OF DRAWINGS

FIG. 1 is a longitudinal cross-sectional view showing one part of a cylinder liner of the present invention.

FIG. 2 is a longitudinal cross-sectional view showing a cylinder liner cast over a cylinder block.

FIG. 3 is a longitudinal cross-sectional view showing a part of another cylinder liner of the present invention.

FIG. 4 is a longitudinal cross-sectional view showing a part of still another cylinder liner of the present invention.

### BEST MODE FOR CARRYING OUT INVENTION

Below, preferred embodiments of the present invention will be explained with reference to the drawings.

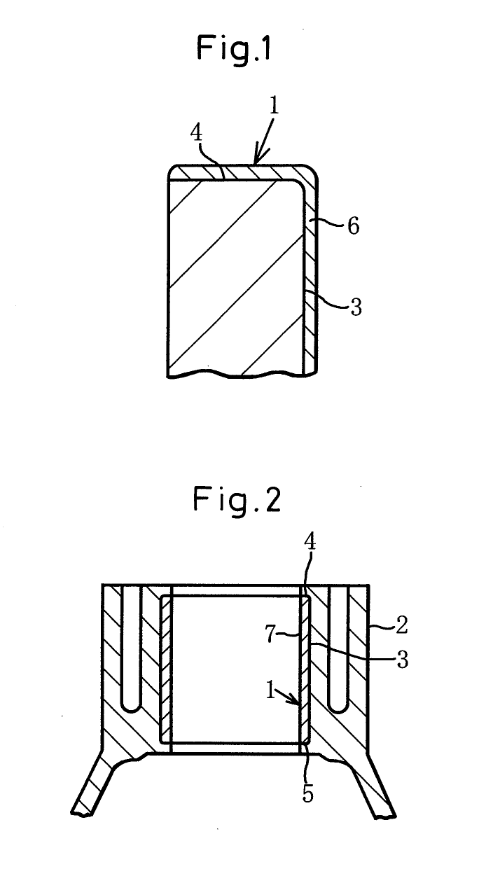

In FIG. 1 and FIG. 2, the cylinder liner 1 is formed from cast iron or steel, while the cylinder block 2 is formed from an aluminum alloy or other light alloy. The cylinder liner 1 is formed with a thermal sprayed coated film 6 at the outer circumferential surface 3 and the top surface 4. As the thermal sprayed material, Al, an Al alloy, Fe, an Fe alloy, Zn, a Zn alloy, Cu, a Cu alloy, etc. is used. The cylinder liner 1 is cast over the cylinder block 2 by insert casting at the outer circumferential surface 3, top surface 4, and bottom surface 5.

Since the cylinder liner of the present invention 1 is formed with a thermal sprayed coated film 6 at the outer circumferential surface 3 and the top surface 4, the adhesion and heat conductivity with the cylinder block 2 are excellent.

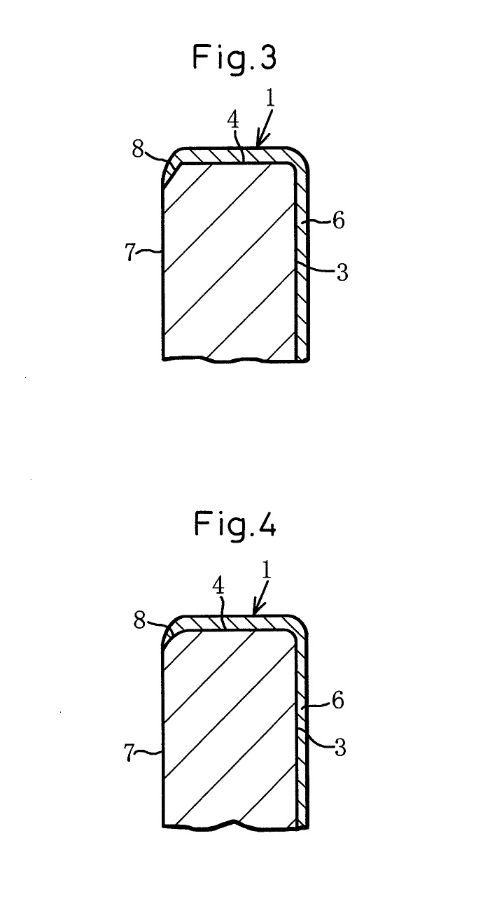

FIG. 3 shows another cylinder liner of the present invention. This cylinder liner 1 is formed with a chamfering 8 part at the connecting edges of the top surface 4 and the inner circumferential surface 7. The thermal sprayed coated film 6 is formed at the top surface 4 part so as to extend over the chamfering 8 part. The chamfering 8 surface is a slanted surface. The rest of the configuration is the same as the above embodiment.

In the present embodiment, the thermal sprayed coated film 6 is formed so as to extend over the chamfering 8 part of the connecting edges of the top surface 4 and the inner circumferential surface 7, so the thermal sprayed coated film 6 is excellent in adhesion.

FIG. 4 shows still another cylinder liner of the present invention. This cylinder liner 1 has a chamfering 8 part, formed at the connecting edges of the top surface 4 and inner circumferential surface 7, which forms an arc shaped surface. The rest of the configuration is the same as the above embodiment.

In the present embodiment as well, the adhesion of the thermal sprayed coated film 6 is excellent.

### REFERENCE SIGNS LIST

1 cylinder liner
2 cylinder block
3 liner outer circumferential surface
4 liner top surface
5 liner bottom surface
6 thermal sprayed coated film
7 liner inner circumferential surface
8 chamfering

1. A cylinder liner cast around a cylinder block by insert casting, said cylinder liner characterized in that a thermal sprayed coated film is formed at the top surface and outer circumferential surface.

2. A cylinder liner as set forth in claim 1, wherein connecting edges of the top surface and the inner circumferential surface are chamfered and the thermal sprayed coated film of said top surface part is formed so as to extend over the chamfering part.

3. A cylinder liner as set forth in claim 2, wherein said chamfered surface is a slanted surface or curved surface.
